(19) United States
(12) Patent Application Publication
(10) Pub. No.: US 2018/0311664 A1
(43) Pub. Date: Nov. 1, 2018

(54) APPARATUS AND METHOD FOR DETERMINING THE PRESENCE OF AN ANALYTE

(71) Applicant: Test Anywhere Technology, Mt. Pleasant, SC (US)

(72) Inventors: Bliss H. Lansing, Mount Pleasant, SC (US); Stephan S. Ogilvie, Cos Cob, CT (US)

(21) Appl. No.: 15/963,912

(22) Filed: Apr. 26, 2018

Related U.S. Application Data
(60) Provisional application No. 62/491,023, filed on Apr. 27, 2017.

(51) Int. Cl. B01L 3/00; G01N 1/02

(52) U.S. Cl. CPC B01L 3/5029; G01N 2001/002; G01N 1/02

(57) ABSTRACT

Described herein is an apparatus for detecting analytes in a sample. The apparatus comprises a flexible body. The flexible body comprises a reagent chamber, a swab channel, adjacent the reagent chamber, a test strip channel, adjacent the swab channel, and a sample chamber open to the reagent chamber, the swab channel, and the test strip channel. The apparatus also comprises at least a first reagent ampule and a second reagent ampule located within the reagent chamber. The first reagent ampule stores a first reagent and the second reagent ampule stores a second reagent different than the first reagent. The apparatus additionally comprises a swab releasably locatable within the swab channel. The apparatus further comprises a test strip located within the test strip channel or releasably locatable within the test strip channel.

### CROSS-REFERENCE TO RELATED APPLICATION

This application claims the benefit of U.S. Provisional Patent Application No. 62/491,023, filed Apr. 27, 2017, which is incorporated herein by reference.

### FIELD

This application is related generally to identifying an analyte, and more specifically to self-administered tests for determining the presence of an analyte, such as for diagnosing medical conditions.

### BACKGROUND

Swabs, such as medical swabs, are often utilized to collect biological specimens for further analysis. Swabs can have an elongated shaft with a fibrous (such as a foam, a cotton, or a polymer) tip, or a serrated metal tip to collect culture samples from various areas of infection in question, including the ear, nose, or throat. Sample specimens may interact with chemical reagents to indicate the presence of one or more types of analyte. Commonly, tests performed include enzymatic tests, monoclonal-based tests, fluorescent tests, agglutination tests, and other tests that provide information regarding a condition of a person being tested or the presence of bacteria.

Conventional specimen collection often requires that the biological specimen be transferred or transported from a swab to a slide, test tube, or other medical apparatus for contact with chemical reagents. Such transportation of the biological specimens poses risks to the accuracy of test results and analysis. This is because there is often an insufficient amount of the biological sample transferred from the test swab to a slide or test tube. Moreover, during transportation there is the potential that the biological specimen may become contaminated due to multiple people handling the biological sample or from contact with various unsterile surfaces. Further, if the biological sample is not transferred and analyzed in a timely manner, the biological sample may become invalid or dry, thus decreasing the reliability of the test.

Many diagnostic tests may also require special equipment or need to be performed by medical professionals. For example, chemical reagents are often measured and mixed manually before introducing the sample specimens. Such handling, measuring, and mixing of chemical reagents is performed by trained medical professionals at a medical services testing site (e.g., hospital, clinic, etc.). Notwithstanding experience and training, medical professionals are prone to mishandling, incorrectly measuring, and insufficiently mixing chemical reagents prior to testing the sample specimen. This, and the need to perform such tests with special equipment by medical professionals at a medical services testing site, can increase the cost and burden on the person being tested and may reduce the likelihood of early detection.

### SUMMARY

The subject matter of the present application has been developed in response to the present state of the art, and in particular, in response to the problems and needs of conventional devices and methods for detecting analytes that have not yet been fully solved. In view of the foregoing, the subject matter of the present application has been developed to provide apparatuses, systems, and methods for detecting analytes in a sample that overcome many of the shortcomings of the prior art. For example, according to some implementations, a self-contained diagnostic apparatus is disclosed that can be administered in a non-hospital or non-clinic setting, such as grocery stores, drug stores, pharmacies, and at home.

Described herein is an apparatus for detecting analytes in a sample. The apparatus comprises a flexible body. The flexible body comprises a reagent chamber, a swab channel, adjacent the reagent chamber, a test strip channel, adjacent the swab channel, and a sample chamber open to the reagent chamber, the swab channel, and the test strip channel. The apparatus also comprises at least a first reagent ampule and a second reagent ampule located within the reagent chamber. The first reagent ampule stores a first reagent and the second reagent ampule stores a second reagent different than the first reagent. The apparatus additionally comprises a swab releasably locatable within the swab channel. The apparatus further comprises a test strip located within the test strip channel or releasably locatable within the test strip channel. The preceding subject matter of this paragraph characterizes example 1 of the present disclosure.

The flexible body further comprises a first sheet adhered to a second sheet. The reagent chamber, the swab channel, the test strip channel, and the sample chamber are defined between the first sheet and the second sheet. The preceding subject matter of this paragraph characterizes example 2 of the present disclosure, wherein example 2 also includes the subject matter according to example 1, above.

Each of the first sheet and the second sheet has a thin-walled construction. The preceding subject matter of this paragraph characterizes example 3 of the present disclosure, wherein example 3 also includes the subject matter according to example 2, above.

Each of the first sheet and the second sheet is planar at least at locations of the flexible body away from the reagent chamber, the swab channel, the test strip channel, and the sample chamber. The preceding subject matter of this paragraph characterizes example 4 of the present disclosure, wherein example 4 also includes the subject matter according to any one of examples 2 or 3, above.

The flexible body forms a blister pack. The preceding subject matter of this paragraph characterizes example 5 of the present disclosure, wherein example 5 also includes the subject matter according to any one of examples 1-4, above.

The apparatus further comprises plates coupled to the flexible body over the reagent chamber, such that the reagent chamber is interposed between the plates. The plates are more rigid than the flexible body. The preceding subject matter of this paragraph characterizes example 6 of the present disclosure, wherein example 6 also includes the subject matter according to any one of examples 1-5, above.

The apparatus additionally comprises a filter between the reagent chamber and the sample chamber. The filter is configured to prevent pieces of the first reagent ampule and the second reagent ampule, when broken, from entering the sample chamber and allow the first reagent and the second reagent to enter the sample chamber. The preceding subject matter of this paragraph characterizes example 7 of the present disclosure, wherein example 7 also includes the subject matter according to any one of examples 1-6, above.

The test strip is releasably locatable within the test strip channel. The preceding subject matter of this paragraph characterizes example 8 of the present disclosure, wherein example 8 also includes the subject matter according to any one of examples 1-7, above.

The test strip is sealed within the test strip channel. The preceding subject matter of this paragraph characterizes example 9 of the present disclosure, wherein example 9 also includes the subject matter according to any one of examples 1-7, above.

The analytes detected by the apparatus comprise streptococcus analytes. The preceding subject matter of this paragraph characterizes example 10 of the present disclosure, wherein example 10 also includes the subject matter according to any one of examples 1-9, above.

The flexible body further comprises a throat portion between the swab channel and the sample chamber. The swab comprises an absorbent pad. The throat portion has a width narrower than a width of the absorbent pad. The preceding subject matter of this paragraph characterizes example 11 of the present disclosure, wherein example 11 also includes the subject matter according to any one of examples 1-10, above.

The sample chamber comprises a first portion, open to the swab channel, and a second portion, open to the test strip channel. The flexible body further comprises a partition dividing the first portion of the sample chamber from the second portion of the sample chamber. The preceding subject matter of this paragraph characterizes example 12 of the present disclosure, wherein example 12 also includes the subject matter according to any one of examples 1-11, above.

The flexible body further comprises a sample channel extending between the first portion of the sample chamber and the second portion of the sample chamber. The partition at least partially defines the sample channel. The preceding subject matter of this paragraph characterizes example 13 of the present disclosure, wherein example 13 also includes the subject matter according to example 12, above.

The sample chamber comprises a first portion, open to the swab channel, and a second portion, open to the test strip channel. The apparatus further comprises a flow regulation element between the first portion of the sample chamber and the second portion of the sample chamber. The flow regulation element is selectively switchable from a first mode, in which the second portion of the sample chamber is closed to the first portion of the sample chamber, to a second mode, in which the second portion of the sample chamber to the first portion of the sample chamber. The preceding subject matter of this paragraph characterizes example 14 of the present disclosure, wherein example 14 also includes the subject matter according to any one of examples 1-13, above.

Also disclosed herein is a method of detecting analytes in a sample. The method comprises squeezing (e.g., manually squeezing) at least a first reagent ampule and a second reagent ampule, located within a reagent chamber of a flexible body, to release a first reagent from the first reagent ampule and a second reagent from the second reagent ampule into a sample chamber of the flexible body to form a reagent mixture in the sample chamber. The method additionally comprises inserting a swab containing a sample into the reagent mixture in the sample chamber of the flexible body to absorb the reagent mixture in the swab. The method further comprises, while the swab is in the flexible body, compressing the swab, with the reagent mixture absorbed in the swab, to release, into the sample chamber of the flexible body, at least a portion of the sample and the reagent mixture absorbed in the swab. The method also comprises exposing a test strip to the sample in the sample chamber of the flexible body. The preceding subject matter of this paragraph characterizes example 15 of the present disclosure.

Compressing the swab comprises manually squeezing opposing sheets of the flexible body against the swab. The preceding subject matter of this paragraph characterizes example 16 of the present disclosure, wherein example 16 also includes the subject matter according to example 15, above.

Compressing the swab comprises passing the swab through a throat portion of the flexible body. The throat portion has a width less than a width of the swab. The preceding subject matter of this paragraph characterizes example 17 of the present disclosure, wherein example 17 also includes the subject matter according to example 15, above.

Exposing the test strip to the sample comprises inserting the test strip through a test strip channel of the flexible body and into the sample chamber of the flexible body. The preceding subject matter of this paragraph characterizes example 18 of the present disclosure, wherein example 18 also includes the subject matter according to any one of examples 15-17, above.

Exposing the test strip to the sample comprise tilting the flexible body such that the at least a portion of the sample and the reagent mixture flows into contact with the test strip. The preceding subject matter of this paragraph characterizes example 19 of the present disclosure, wherein example 19 also includes the subject matter according to any one of examples 15-17, above.

Exposing the test strip to the sample comprises selectively switching a flow regulation element from a first mode, in which exposure of the test strip to the at least a portion of the sample and the reagent mixture is prevented, to a second mode of operation, in which exposure of the test strip to the at least a portion of the sample and the reagent mixture is allowed. The preceding subject matter of this paragraph characterizes example 20 of the present disclosure, wherein example 20 also includes the subject matter according to any one of examples 15-19, above.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a perspective view of a self-contained diagnostic apparatus, according to one or more examples of the present disclosure;

FIG. 2 is a front view of the self-contained diagnostic apparatus of FIG. 1, shown with a first sheet of a body of the apparatus removed for convenience, according to one or more examples of the present disclosure;

FIG. 3 is a cross-sectional side view of the self-contained diagnostic apparatus of FIG. 1, taken along a line similar to the line 3-3 of FIG. 2, according to one or more examples of the present disclosure;

FIG. 4 is a front view of the self-contained diagnostic apparatus of FIG. 1, shown in a first stage of operation and with the first sheet of the body of the apparatus removed for convenience, according to one or more examples of the present disclosure;

FIG. 5 is a front view of the self-contained diagnostic apparatus of FIG. 1, shown in a second stage of operation and with the first sheet of the body of the apparatus removed for convenience, according to one or more examples of the present disclosure;

FIG. 6 is a front view of the self-contained diagnostic apparatus of FIG. 1, shown in a third stage of operation and with the first sheet of the body of the apparatus removed for convenience, according to one or more examples of the present disclosure;

FIG. 7 is a front view of a self-contained diagnostic apparatus, shown with a first sheet of a body of the apparatus removed for convenience, according to one or more examples of the present disclosure;

FIG. 8 is a front view of the self-contained diagnostic apparatus of FIG. 7, shown in a first stage of operation and with the first sheet of the body of the apparatus removed for convenience, according to one or more examples of the present disclosure;

FIG. 9 is a front view of the self-contained diagnostic apparatus of FIG. 7, shown in a second stage of operation and with the first sheet of the body of the apparatus removed for convenience, according to one or more examples of the present disclosure;

FIG. 10 is a front view of the self-contained diagnostic apparatus of FIG. 7, shown in a third stage of operation and with the first sheet of the body of the apparatus removed for convenience, according to one or more examples of the present disclosure;

FIG. 11 is a front view of the self-contained diagnostic apparatus of FIG. 7, shown in a fourth stage of operation and with the first sheet of the body of the apparatus removed for convenience, according to one or more examples of the present disclosure; and

FIG. 12 is schematic flow chart of a method of detecting analytes in a sample, according to one or more examples of the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

Advances in technology, coupled with consumer demand, have redefined trends in the health industry and pushed the market towards developing convenient health care products that do not require a visit to a hospital or clinic. For example, in the past, if a woman wanted to determine if she was pregnant, the woman would have to visit a doctor to have a pregnancy test performed by a medical professional. Now, however, a woman has the ability to take an at home pregnancy test and administer the test herself. In another example, a subject who is interested in taking measurements of himself or herself, such as weight, height, and body mass index, can use a diagnostic machine found in drug stores, pharmacies, and groceries stores instead of visiting a hospital or clinic. The shift from patients to consumers, who can take charge of their own health, has made non-hospital and non-clinic testing a growing multi-billion dollar industry worldwide. Drugstores are carrying or administering an increased number of medical tests that can be performed in non-hospital and non-clinic settings because people desire the financial savings, convenience, privacy, and other benefits that arise from managing their health care at more convenient locations.

In order to minimize and/or reduce risks that may produce invalid tests, and thus increasing test reliability and accessibility, a self-contained test apparatus is disclosed herein. The self-contained test apparatus can enhance contact between a specimen and reagents by reducing the amount of time it takes to perform the test and the number of people handling a sample. Moreover, the self-contained test apparatus simplifies and streamlines the diagnostic process by eliminating the need to handle and measure reagents. The risk of contamination by direct contact can be minimal as the compact, self-contained design can essentially eliminate the transportation of the specimen across unsterile environments. Additionally, the self-contained test apparatus can be designed so that a single tester (e.g., person being tested) can immediately perform the analysis on site, without delay. This simplicity and efficiency helps preserves the specimen and ensures greater test reliability.

In some embodiments disclosed herein, the self-contained test apparatus is aesthetically appealing, easy-to-use, and configured to analyze and/or detect types of bacteria such as streptococcal group A. The self-contained test apparatus can provide for minimal risk of contamination or testing error because the apparatus can be designed to operate in a series of sequential steps to ensure optimal testing accuracy. In other words, to reduce test contamination, effort, and the need for medical expertise, the self-contained test apparatus may facilitate a sequential progression of test components and stages that can limit and/or reduce errors by a tester. The self-contained test apparatus helps to ensure the test can be administered in a consumer friendly manner, where any person of appropriate age or of minimal professional training may use the testing kit at home, drug stores, pharmacies, or any other desired location. Moreover, some embodiments describe a simple, compact, and easy-to-use self-contained test apparatus where all the components within the apparatus may be isolated to ensure the components are initially sanitary and clean.

Generally, some example embodiments of the self-contained test apparatus described herein can offer a benefit of convenient testing, and may be conveniently packaged, easily transported (e.g., to remote locations or mobile care stations), and easy to administer or perform. Individuals may be reliably screened and/or tested for the presence of bacteria, or other analytes, using the self-contained test apparatus in convenient locations and in a timely fashion, thus avoiding the added cost and inconvenience of a visit to a physician's office.

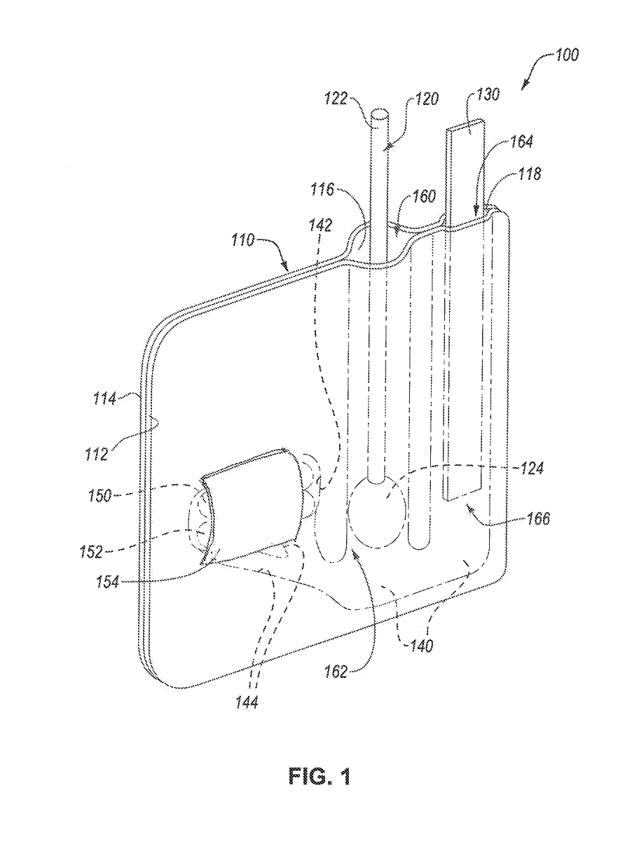

Referring to FIGS. 1-6, one embodiment of a self-contained diagnostic apparatus 100 is shown. The apparatus 100 includes a body 110 (e.g., a flexible body) configured to hold a first reagent ampule 150, a second reagent ampule 152, a swab 120, and a test strip 130. In some implementations, the apparatus 100 is packaged as a self-contained kit that is pre-assembled as shown in FIG. 1 prior to packaging, shipment, and use by an end user. Although not shown, in one implementation, the entire apparatus 100 is sealed within an enclosed package (e.g., pouch, bag, shrink-wrap, etc.), for packaging, storing, and shipping of the apparatus 100, that a user can open to access the apparatus 100 and then discard. The enclosed package maintains the sterility and arrangement of the components of the apparatus 100 prior to use of the apparatus 100 by an end user.

In one embodiment, the body 110 takes the form of a blister pack with a first sheet 112 adhered to a second sheet 114. Each of the first sheet 112 and the second sheet 114 has a generally 2-dimensional shape. For example, other than chambers and channels formed in the body 110, as will be described in more detail below, the first sheet 112 and the second sheet 114 are flat or planar (e.g., non-tubular). The first sheet 112 and the second sheet 114 have a thin-walled construction. In other words, each of the first sheet 112 and the second sheet 114 has a thickness or depth that is significantly less than a length and width of the respective first sheet 112 and second sheet 114. Furthermore, in one implementation, the first sheet 112 and the second sheet 114 are made of a flexible material, such as a flexible polymer. Accordingly, the body 110 can be flexible. The flexible material is a resilient (e.g., elastic) material in certain implementations. According to some implementations, the first sheet 112 and/or the second sheet 114 are transparent, partially transparent, or selectively transparent, such that an interior of one or more of the channels and chambers of the body 110 can be visible from outside of the channels and chambers. In an implementation, the first sheet 112 and the second sheet 114 are made of a clear, flexible, plastic. The outer periphery of the body 110 can have any of various shapes. In the illustrated implementation, the body 110 has a square or rectangular shape.

The body 110 includes various channels and chambers formed between the first sheet 112 and the second sheet 114. In the illustrated embodiment, the channels and chambers are formed by bonding together or adhering together the first sheet 112 and the second sheet 114 about the channels and chambers and leaving the first sheet 112 and the second sheet 114 unbonded at the channels and chambers. In other words, the channels and chambers are formed between the first sheet 112 and the second sheet 114 where the first sheet 112 and the second sheet 114 are not bonded to each other. In some implementations, to increase the volume of the channels and chambers and to facilitate the storage or passage of components or fluids in the channels and chambers, bulges or grooves can be formed in one or more of the first sheet 112 and the second sheet 114 at the location of the channels and chambers. For example, in the illustrated embodiment, opposing bulges are formed in the first sheet 112 and the second sheet 114 to help define the channels and chambers of the body 110. However, in other embodiments, one of the first sheet 112 or the second sheet 114 remains flat at the channels and chambers, while the other of the first sheet 112 or the second sheet 114 has a bulge or groove at the channels and chambers. For example, the second sheet 114 can be flat and made from a harder (e.g., less flexible) material than the first sheet 112 and the first sheet 112 can include bulges that define the channels and chambers.

The channels and chambers of the body 110 include a reagent chamber 142, a sample chamber 140, a swab channel 116, a test strip channel 118, and a reagent channel 144. The reagent chamber 142 stores at least two ampules each containing a different reagent. For example, the reagent chamber 142 stores the first reagent ampule 150 and the second reagent ampule 152. The swab channel 116 is adjacent (e.g., laterally adjacent) and partitioned from the reagent chamber 142. Generally, the swab channel 116 temporarily or releasably stores the swab 120, which includes a handle 122 and an absorbent pad 124 coupled to an end of the handle 122. The swab channel 116 includes an inlet 160 and an outlet 162. The test strip channel 118 is adjacent (e.g., laterally adjacent) and partitioned from the swab channel 116. In the illustrated embodiments, the swab channel 116 is laterally between the reagent chamber 142 and the test strip channel 118. However, the reagent chamber 142 can be laterally between the swab channel 116 and the test strip channel 118 or the test strip channel 118 can be laterally between the reagent chamber 142 and the swab channel 116. Accordingly, the reagent chamber 142, the swab channel 116, and the test strip channel 118 are adjacent (e.g., laterally adjacent) each other and laterally partitioned from each other.

Generally, in the embodiment shown in FIGS. 1-6, the test strip channel 118 temporarily or releasably stores the test strip 130, which is configured to determine the presence of an analyte in a reagent mixture 180. The test strip 130 includes antibodies, specific to the analyte being tested, coated on a substrate. If present, the analyte reacts with the antibodies on the test strip 130 to produce a visible color change, or other visual indicator, on the test strip, which indicates a result, such as a positive result. The test strip channel 118 includes an inlet 164 and an outlet 166. Although one test strip 130 is shown in the illustrated example, the self-contained diagnostic apparatus 100 includes more than one test strip 130 in other examples.

Although in the embodiments shown in FIGS. 1-6, the inlet 160 of the swab channel 116 and the inlet 164 of the test strip channel 118 is open and the swab 120 and the test strip 130 extend out of the body 110 through the inlet 160 and the inlet 164 when packaged for distribution and prior to use, in other embodiments, the inlet 160 and the inlet 164 are temporarily closed when packaged for distribution and prior to use. In such other embodiments, the swab 120 is temporarily sealed in the swab channel 116 and the test strip 130 is temporarily sealed in the test strip channel 118 when packaged. Prior to use, the temporary seals are broken and the swab 120 and the test strip 130 are removed from the respective channels as defined in more detail below. The temporary seals can be any of various types of seals, such as clips or adhesives. Such a configuration may help to retain the swab 120 and the test strip 130 in the body 110 during distribution and handling prior to use.

The apparatus 100 can be configured to detect any of various organic or inorganic analytes (e.g., pathogens, antigens, and/or the like). For example, the apparatus 100 can be configured to detect any one or more of, but not limited to toxins, organic compounds, inorganic compounds (e.g., lead), proteins, peptides, microorganisms, amino acids, nucleic acids, hormones, steroids, vitamins, drugs (including those administered for therapeutic purposes as well as those administered for illicit purposes), drug intermediaries or byproducts, bacteria, virus particles, and metabolites of or antibodies to any of the above substances. Specific examples of some analytes include ferritin, creatinine kinase MB (CK-MB), digoxin, phenytoin, phenobarbitol, carbamazepine, streptococcus, vancomycin, gentamycin, theophylline, valproic acid, quinidine, lueteinizing hormone (LH), follicle stimulating hormone (FSH), estradiol, progesterone, C-reactive protein, lipocalins, IgE antibodies, cytokines, vitamin B2 micro-globulin, glycated hemoglobin (Gly. Hb), cortisol, digitoxin, N-acetylprocainamide (NAPA), procainamide, antibodies to rubella (such as rubella-IgG and rubella IgM), antibodies to toxoplasmosis (such as toxoplasmosis IgG (Toxo-IgG) and toxoplasmosis IgM (Toxo-IgM), testosterone, salicylates, acetaminophen, hepatitis B virus surface antigen (HBsAg), antibodies to hepatitis B core antigen, such as anti-hepatitis B core antigen IgG and IgM (Anti-HBC), human immunodeficiency virus 1 and 2 (HIV 1 and 2), human T-cell leukemia virus 1 and 2 (HTLV), hepatitis B e antigen (HBeAg), antibodies to hepatitis B e antigen (Anti-HBe), influenza virus, thyroid stimulating hormone (TSH), thyroxine (T4), total triiodothyronine (Total T3), free triiodothyronine (Free T3), carcinogembryoic antigen (CEA), lipoproteins, cholesterol, triglycerides, and alpha fetoprotein (AFP).

Accordingly, although some embodiments of the apparatus 100 and associated methods are described herein as being directed to medical applications for determining the presence of biological analytes, the apparatus 100 can be directed to non-medical applications for determining the presence of biological or non-biological analytes. For this reason, use of the word “medical” can be replaced with any of various other suitable industries and use of the word “biological” can be replaced with “non-biological.”

The sample chamber 140 is open to the outlet 162 of the swab channel 116 and the outlet 166 of the test strip channel 118. Accordingly, the swab 120 is positionable in the sample chamber 140 via the outlet 162 of the swab channel 116. Similarly, the test strip 130 is positionable in the sample chamber 140 via the outlet 166 of the test strip channel 118. The reagent channel 144 extends from the reagent chamber 142 to the sample chamber 140. In other words, the reagent channel 144 is open to the reagent chamber 142 and the sample chamber 140. In some implementations, a filter 156 is positioned between the reagent chamber 142 and the reagent channel 144 to prevent pieces 153 of the first reagent ampule 150 and the second reagent ampule 152, after breaking the ampules as will be explained below, from passing through the reagent channel 144 and into the sample chamber 140. Alternatively, the filter 156 can be positioned in the reagent channel 144 at any location between the reagent chamber 142 and the sample chamber 140.

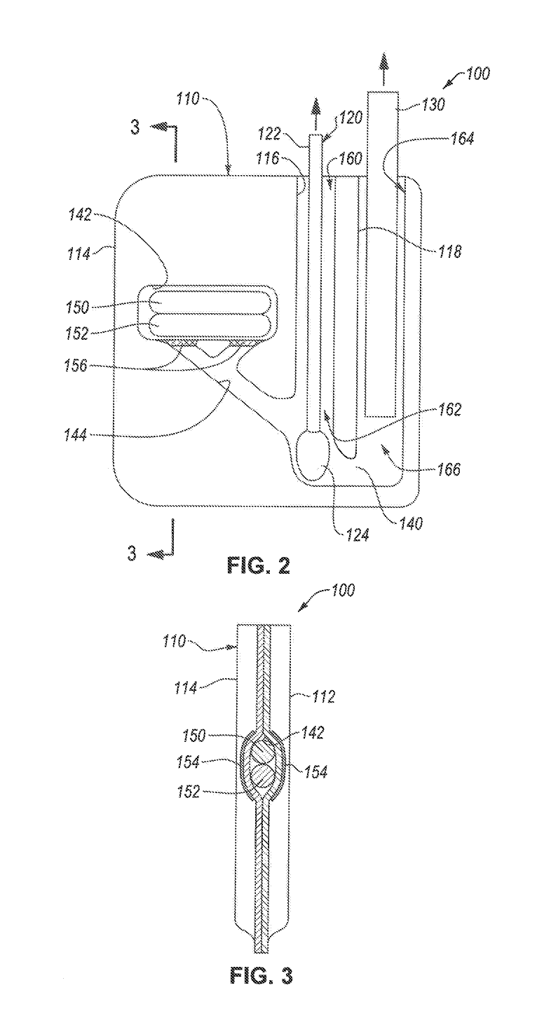

Referring to FIGS. 1 and 3, in some embodiments, the body 110 further includes plates 154 coupled to the first sheet 112 and the second sheet 114, respectively, over the reagent chamber 142. The plates 154 effectively sandwich the reagent chamber 142 between the plates 154. In some implementations, the plates 154 are made of a material stronger (e.g., more rigid) than the first sheet 112 and the second sheet 114. For example, the plates 154 are made from a harder (e.g., greater hardness) or thicker polymer compared to that of the first sheet 112 and the second sheet 114. The plates 154 can be transparent like the first sheet 112 and the second sheet 114 or opaque. Moreover, the plates 154 can be bonded or adhered to the outer surfaces of the first sheet 112 and the second sheet 114. However, in some implementations, the plates 154 are integrated into the first sheet 112 and the second sheet 114 to form a one-piece monolithic construction with the first sheet 112 and the second sheet 114. For example, the plates 154 can simply be thicker portions of the first sheet 112 and the second sheet 114. For the sake of simplicity in showing other features of the apparatus 100, the plates 154 are not shown in FIGS. 2 and 4-6.

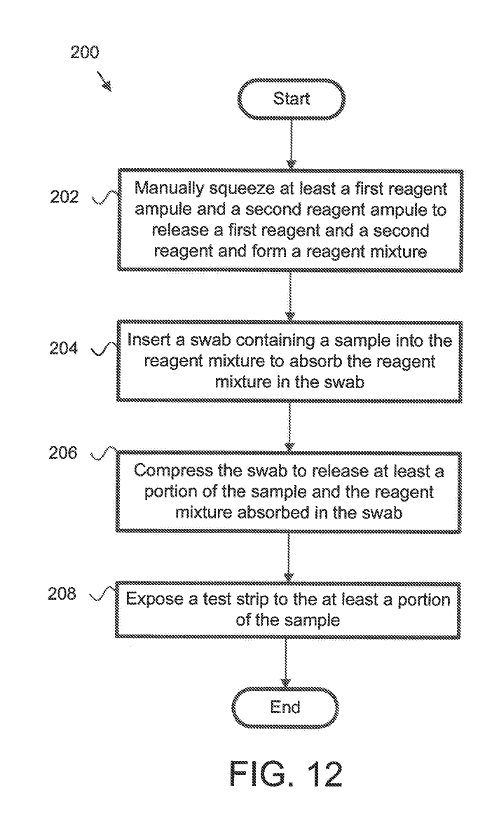

Referring to FIG. 12, according to one embodiment, a method 200 of use of the self-contained diagnostic apparatus 100 to detect an analyte in a sample, a user first removes the swab 120 and at least partially removes the test strip 130 from the body 110 of an unused apparatus 100. In some implementations, removal of the test strip 130 merely includes moving the test strip 130 out of the sample chamber 140 while keeping a portion of the test strip 130 within the test strip channel 118. The swab 120 is then used to collect a biological sample 125 from a test subject (e.g., a patient). Collecting the biological sample 125 with the swab 120 includes contacting the test subject with the absorbent pad 124 of the swab 120. For example, in the case of testing for streptococcus, the absorbent pad 124 is swiped across the back of the throat of the test subject. When testing for other analytes, such as influenza, human immunodeficiency virus (HIV), hepatitis, rubella, lyme disease, drugs, and the like, the absorbent pad 124 can be placed in contact with other parts of the test subject's body by swiping or using other methods. With the biological sample 125 on the absorbent pad 124, the swab 120 is ready to be reinserted back into the swab channel 116 via the inlet 160 of the swab channel 116.

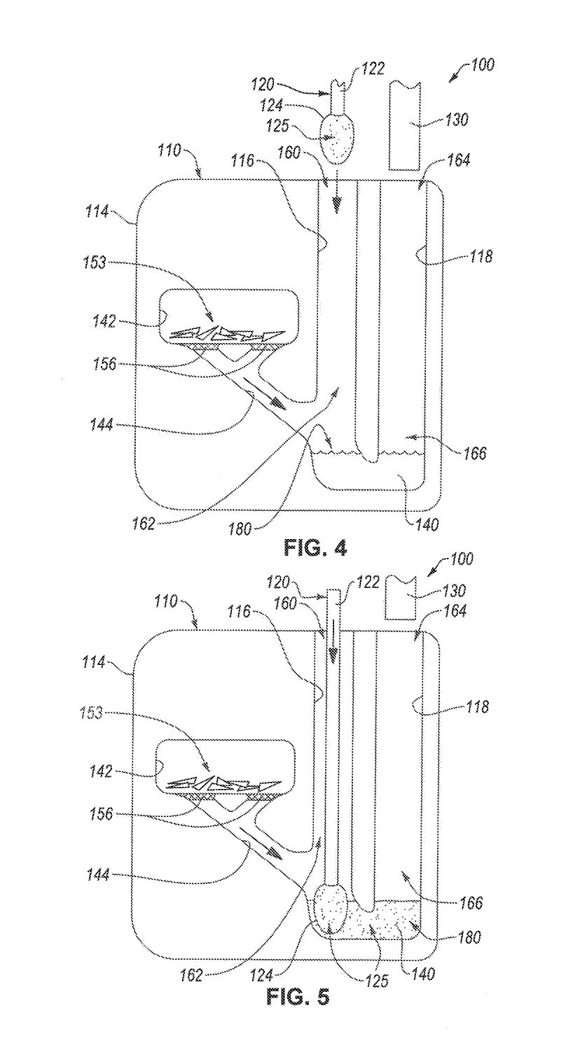

Ultimately, at step 202 of the method 200, the swab 120 is reinserted back into the swab channel 116 such that the absorbent pad 124 with the biological sample 125 is positioned within the sample chamber 140. However, prior to fully reinserting the swab 120 back into the swab channel 116, at step 204 of the method 200, the first reagent ampule 150 and the second reagent ampule 152 are crushed to release the first reagent stored in the first reagent ampule 150 and the second reagent stored in the second reagent ampule 152. In one implementation, due to the flexibility of at least one of the first sheet 112 and the second sheet 114 of the body 110, the first reagent ampule 150 and the second reagent ampules 152 are crushed by manually squeezing or collapsing the reagent chamber 142. The pressure applied to squeeze or collapse the reagent chamber 142, when sufficient, compresses the ampules until they are crushed into the pieces 153 as shown in FIGS. 4-6. As the ampules are crushed, the reagents stored within them are released into the reagent chamber 142 and begin to mix together to form the reagent mixture 180. Mixing the first and second reagents together effectively activates the reagent mixture 180 and places the reagent mixture 180 in a condition to isolate targeted analytes in the biological sample 125. Although the illustrated embodiments show an apparatus 100 with two ampules each with a different single reagent, in other embodiments, the apparatus 100 can have two ampules each with more than one reagent or more than two ampules each with a different single reagent or more than one reagent.

As defined herein, an ampule is any container configured to contain and release a reagent. Moreover, although the present disclosure provides examples of ampules that are crushed or broken to release a reagent, the ampules can containers other than those that are crushable and the reagent can be released in any of various ways other than crushing or breaking the ampule. For example, the ampule can have a one-way valve that releases the reagent under an applied pressure.

The reagents of the ampules are dependent on the analyte being detected. Examples of various reagents which may be used to detect and identify analytes include one or more of various well known test reagents. Such reagents may be present in either liquid or solid/powder form. Commercially available reagents may be used. For example, a test reagent such as N,N,N,N tetra methyl-p-phenylenediamine dihydrochloride may be used for detecting gonorrhea. Other test reagents such as dimethyl amino-cinnaminaldehyde, beta b galactosidase substrates, gamma glutamylamino peptidase and prolylamine peptidase may also be used for detecting specific species of the genus Neisseria. Further test reagents may include, but are not limited to, hippuric acid for detecting Group B Streptococcus, L-pyrrolidonyl beta naphthylamide and esculin for detecting Group A Streptococcus, and acid or mineral acids, such as citric, acetic, and hydropchloric acid and sodium nitrite, for detecting Group A Streptococcus antigen.

Referring to FIG. 4, with the apparatus body 110 in an upright position (e.g., the swab channel 116 and the test strip channel 118 being lengthwise substantially vertical, such as shown in FIGS. 1-6), after opening (e.g., crushing, breaking, etc.) the first reagent ampule 150 and the second reagent ampule 152, the pieces 153 remain in the reagent chamber 142 due to the filter 156, but the first reagent and the second reagent released from the ampules pass through the filter 156, along the reagent channel 144, and into the sample chamber 140 as the mixture 180. Again, at step 202, the swab 120, with the biological sample 125 contained by the absorbent pad 124, is then reinserted back into the swab channel 116 until the absorbent pad 124 is located within the sample chamber 140 and in contact with the mixture 180. Contact with the mixture 180 effectuates the absorption of at least a portion of the mixture 180 by the absorbent pad 124. At step 206 of the method 200, a user then compresses the absorbent pad 124 of the swab 120 (e.g., manually squeezes the sample chamber 140 with the absorbent pad 124 in it), such by pinching the body 110 with a thumb and finger at the sample chamber 140, until at least a portion of the biological sample 125 is released with the mixture 180 squeezed from the absorbent pad 124 and enters the sample chamber 140.

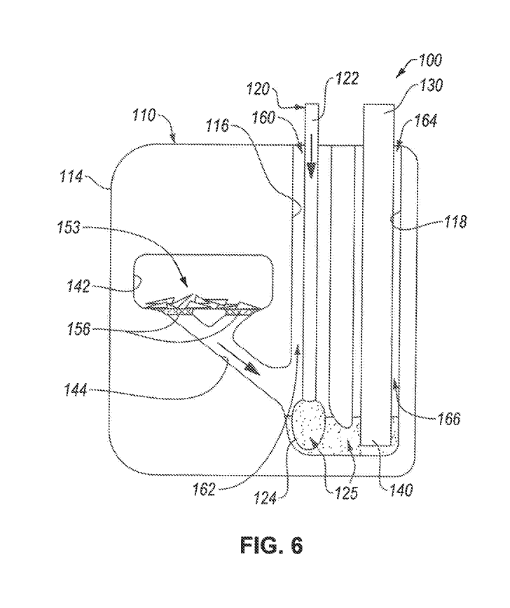

As shown in FIGS. 5 and 6, with the biological sample 125 in the reagent mixture 180 within the sample chamber 140, at step 208 of the method 200, a user then exposes the test strip 130 to the biological sample 125 in the sample chamber 140. In one example, step 208 is accomplished by reinserting the test strip 130 back into the test strip channel 118 and moves the test strip 130 until the test strip 130 is located within the reagent mixture 180 in the sample chamber 140. If the biological sample 125 includes the analyte(s) being tested, a visual indication will appear on the test strip 130. Otherwise, if the biological sample 125 has no analyte(s), then no visual indication, or an alternative visual indication, will be provided by the test strip 130. After confirmation of the presence or absence of analytes by visual inspection of the test strip 130, the self-contained diagnostic apparatus 100 can be discarded.

Although the body 110 in the illustrated examples is shown to have a specified number of chambers and channels, it is recognized that in other examples, the body 110 can have more chambers and/or channels as desired. For example, the body 110 have double the chambers and channels to facilitate two tests with one body 110. As another example, one or more additional channels could be added to the body 110 to facilitate the inclusion of external reagents, additional test strips, access for reading/interpretation devices, and the like. In other words, the subject matter of the present disclosure is not limited to the number of chambers and channels shown in the illustrated examples.

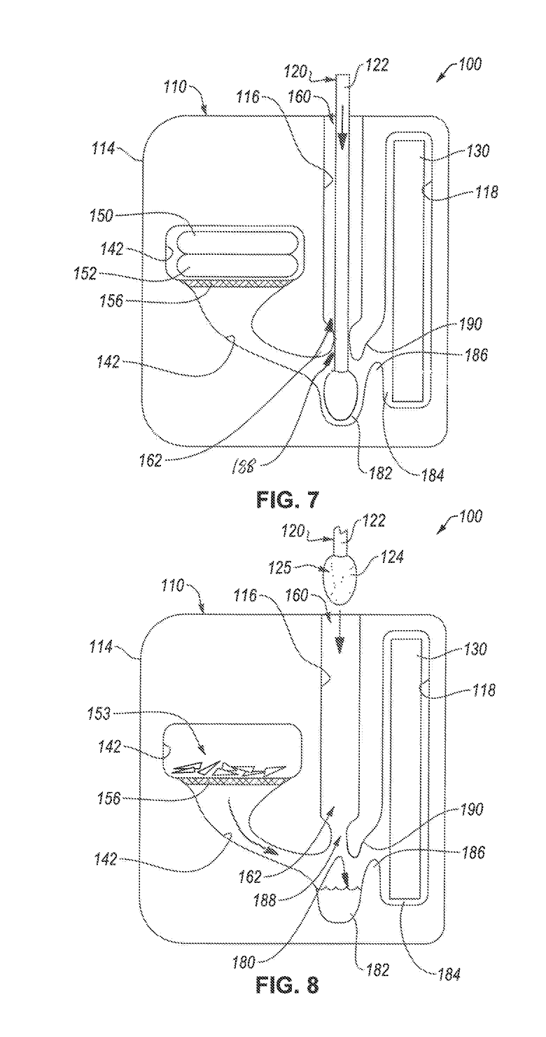

Referring to FIGS. 7-11, another embodiment of a self-contained diagnostic apparatus 100 is shown. The apparatus 100 in FIGS. 7-11 includes features similar to the features of the apparatus in FIG. 1-6, with like numbers referring to like features. Accordingly, unless otherwise noted, the description, including the structure, function, and advantages, of the features of the apparatus 100 of FIGS. 1-6 presented above are applicable to the analogous features of the apparatus 100 of FIGS. 7-11.

The body 110 of the apparatus 100 of FIGS. 7-11 includes a sample chamber 140 that is divided into a first portion 182 and a second portion 184. Moreover, the body 110 of the apparatus 100 of FIGS. 7-11 also includes a throat portion 188 between the outlet 162 of the swab channel 116 and the first portion 182 of the sample chamber 140. The throat portion 188 has a width that is narrower than a width of the absorbent pad 124. The first portion 182 of the sample chamber 140 is open to the throat portion 188 and the reagent channel 142. The second portion 184 of the sample chamber 140 is not open to the throat portion 188 or the reagent channel 142. Rather, the second portion 184 is only open to the test strip channel 118 and the first portion 182. More specifically, the second portion 184 is open to the first portion 182 via a sample channel 190, which is at least partially defined by a partition 186. The partition 186 at least partially divides the first portion 182 from the second portion 184 such that when the body 110 is in an upright position (see, e.g., FIG. 8), the mixture 180 is prevented, by the partition 186, from entering the second portion 184. Because the test strip channel 118 does not have an inlet, the test strip channel 118 can be considered a test strip chamber, or closed channel, from which the test strip 130 is not removable or not movable and in which the test strip 130 is sealed. However, in some implementations, the test strip channel 118 of the body 110 of the apparatus in FIGS. 7-11 may have an inlet through which the test strip 130 can be removable from or insertable into the test strip channel 118. A portion of the test strip 130 is located within the second portion 184. In the apparatus 100 of FIGS. 7-11, the first portion 182 and the second portion 184 cooperatively form a sample chamber of the apparatus.

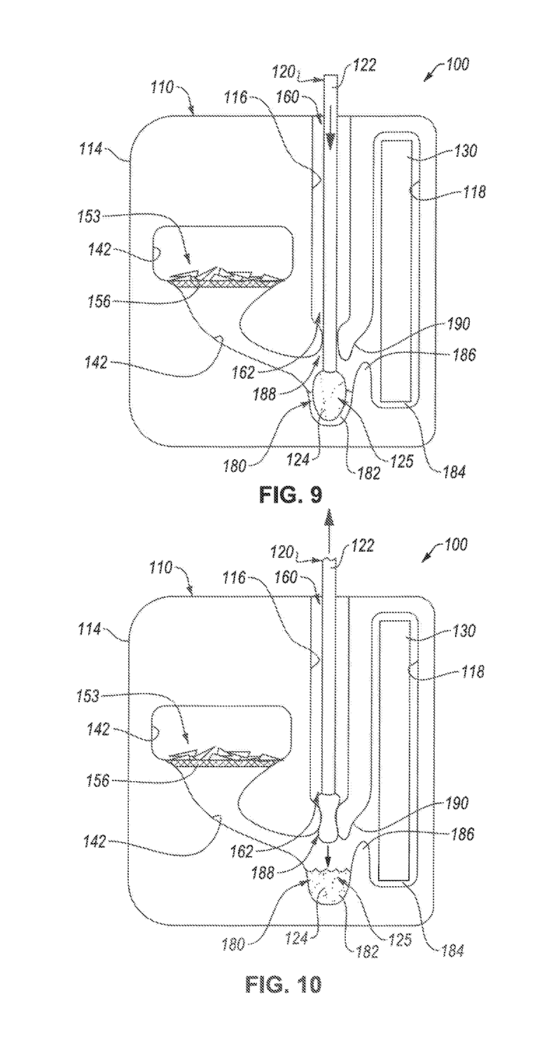

Referring to FIGS. 8 and 9, after the first reagent ampule 150 and the second reagent ampule 152 are opened to form the reagent mixture 180 in the first portion 182 and after the swab 120 with the biological sample 125 is reinserted back into the swab channel 116 such that the absorbent pad 124 with the biological sample 125 is positioned within the reagent mixture 180 in the first portion 182 (according to, e.g., step 202 and step 204 of the method 200), the swab 120 is drawn toward the inlet 160 such that the absorbent pad 124 passes through the throat portion 188. As the absorbent pad 124 passes through the throat portion 188, the absorbent pad 124 is compressed (e.g., squeezed) by converging walls of the throat portion 188 (according to, e.g., step 206 of the method 200). The squeezing action on the absorbent pad 124 acts to release the reagent mixture 180 and biological sample 125 from the absorbent pad 124 into the first portion 182 as shown in FIG. 10.

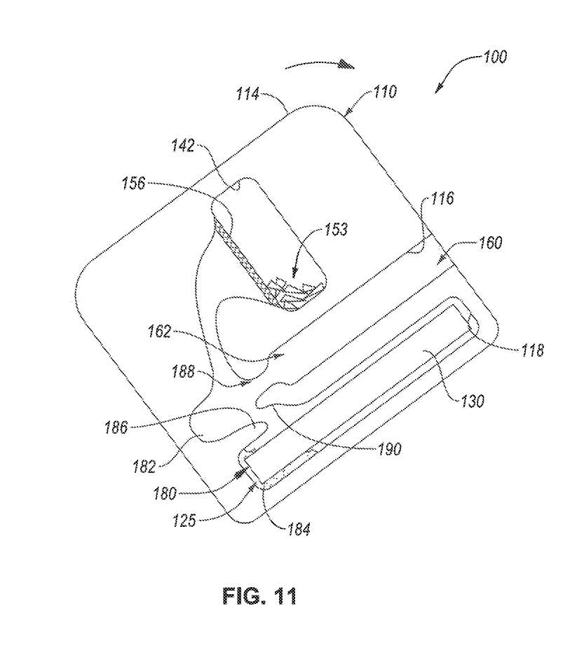

Referring to FIG. 11, the body 110 can then be tilted, about an axis perpendicular to the body 110 and parallel to horizontal, such that the biological sample 125 and reagent mixture 180 in the first portion 182 passes around the partition 186, through the sample channel 190, and into the second portion 184 to expose the test strip 130 to the biological sample 125 (according to, e.g., step 208 of the method 200).

Referring to FIG. 7, in some implementations, a flow regulation element 192 or barrier is positioned in the sample channel 190. The flow regulation element 192 can be selectively switchable from a first mode of operation to a second mode of operation, or switchable between the first mode of operation and the second mode of operation. In the first mode the flow regulation element 192 closes off the second portion 184 from the first portion 182 and in the second mode the flow regulation element 192 open the second portion 184 to the first portion 182, thus respectively preventing or allowing flow of the biological sample 125 and the reagent mixture 180 through the sample channel 190 from the first portion 182. In one implementation, the flow regulation element 192 is a valve or other mechanism that is closed to prevent flow of the biological sample 125 and the reagent mixture 180 through the sample channel 190 or opened to allow flow of the biological sample 125 and the reagent mixture 180 through the sample channel 190. The flow regulation element 192 can be selectively reversible between open and closed positions in some implementations, while in other implementations, the flow regulation element 192 is initially closed and then permanently opened, such as by deforming (e.g., breaking, rupturing, etc.) the flow regulation element 192 with a force (e.g., manual compression). In the second portion 184, the biological sample 125 and the reagent mixture 180 comes in contact with the test strip 130. As presented above, if the biological sample 125 includes the analyte(s) being tested, a visual indication will appear on the test strip 130. Otherwise, if the biological sample 125 has no analyte(s), then no visual indication, or an alternative visual indication, will be provided by the test strip 130.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1. An apparatus for detecting analytes in a sample, comprising:
a flexible body, comprising:
a reagent chamber;
a swab channel, adjacent the reagent chamber;
a test strip channel, adjacent the swab channel; and
a sample chamber open to the reagent chamber, the swab channel, and the test strip channel;
at least a first reagent ampule and a second reagent ampule located within the reagent chamber, wherein the first reagent ampule stores a first reagent and the second reagent ampule stores a second reagent different than the first reagent;
a swab releasably locatable within the swab channel; and
a test strip located within the test strip channel or releasably locatable within the test strip channel.

2. The apparatus according to claim 1, wherein:
the flexible body further comprises a first sheet adhered to a second sheet; and
the reagent chamber, the swab channel, the test strip channel, and the sample chamber are defined between the first sheet and the second sheet.

3. The apparatus according to claim 2, wherein each of the first sheet and the second sheet has a thin-walled construction.

4. The apparatus according to claim 2, wherein each of the first sheet and the second sheet is planar at least at locations of the flexible body away from the reagent chamber, the swab channel, the test strip channel, and the sample chamber.

5. The apparatus according to claim 1, wherein the flexible body forms a blister pack.

6. The apparatus according to claim 1, further comprising plates coupled to the flexible body over the reagent chamber, such that the reagent chamber is interposed between the plates, wherein the plates are more rigid than the flexible body.

7. The apparatus according to claim 1, further comprising a filter between the reagent chamber and the sample chamber, wherein the filter is configured to prevent pieces of the first reagent ampule and the second reagent ampule, when broken, from entering the sample chamber and allow the first reagent and the second reagent to enter the sample chamber.

8. The apparatus according to claim 1, wherein the test strip is releasably locatable within the test strip channel.

9. The apparatus according to claim 1, wherein the test strip is sealed within the test strip channel.

10. The apparatus according to claim 1, wherein the analytes detected by the apparatus comprise streptococcus analytes.

11. The apparatus according to claim 1, wherein:
the flexible body further comprises a throat portion between the swab channel and the sample chamber;
the swab comprises an absorbent pad; and
the throat portion has a width narrower than a width of the absorbent pad.

12. The apparatus according to claim 1, wherein:
the sample chamber comprises a first portion, open to the swab channel, and a second portion, open to the test strip channel; and
the flexible body further comprises a partition dividing the first portion of the sample chamber from the second portion of the sample chamber.

13. The apparatus according to claim 12, wherein:
the flexible body further comprises a sample channel extending between the first portion of the sample chamber and the second portion of the sample chamber; and
the partition at least partially defines the sample channel.

14. The apparatus according to claim 1, wherein:
the sample chamber comprises a first portion, open to the swab channel, and a second portion, open to the test strip channel;
the apparatus further comprises a flow regulation element between the first portion of the sample chamber and the second portion of the sample chamber; and
the flow regulation element is selectively switchable from a first mode, in which the second portion of the sample chamber is closed to the first portion of the sample chamber, to a second mode, in which the second portion of the sample chamber to the first portion of the sample chamber.

15. A method of detecting analytes in a sample, comprising:
queezing at least a first reagent ampule and a second reagent ampule, located within a reagent chamber of a flexible body, to release a first reagent from the first reagent ampule and a second reagent from the second reagent ampule into a sample chamber of the flexible body to form a reagent mixture in the sample chamber;
inserting a swab containing a sample into the reagent mixture in the sample chamber of the flexible body to absorb the reagent mixture in the swab;
while the swab is in the flexible body, compressing the swab, with the reagent mixture absorbed in the swab, to release, into the sample chamber of the flexible body, at least a portion of the sample and the reagent mixture absorbed in the swab; and
exposing a test strip to the sample in the sample chamber of the flexible body.

16. The method according to claim 15, wherein compressing the swab comprises manually squeezing opposing sheets of the flexible body against the swab.

17. The method according to claim 15, wherein:
compressing the swab comprises passing the swab through a throat portion of the flexible body; and
the throat portion has a width less than a width of the swab.

18. The method according to claim 15, wherein exposing the test strip to the sample comprises inserting the test strip through a test strip channel of the flexible body and into the sample chamber of the flexible body.

19. The method according to claim 15, wherein exposing the test strip to the sample comprise tilting the flexible body such that the at least a portion of the sample and the reagent mixture flows into contact with the test strip.

20. The method according to claim 15, wherein exposing the test strip to the sample comprises selectively switching a flow regulation element from a first mode, in which exposure of the test strip to the at least a portion of the sample and the reagent mixture is prevented, to a second mode of operation, in which exposure of the test strip to the at least a portion of the sample and the reagent mixture is allowed.
